(19) United States
(12) Patent Application Publication
(10) Pub. No.: US 2019/0041728 A1
(43) Pub. Date: Feb. 7, 2019

(54) PORTABLE SYSTEM TO CREATE THE DISPLAY PLATFORM

(71) Applicant: Vasudev P ANKOLIYA, SURAT (IN)

(72) Inventor: ANKOLIYA Vasudev, SURAT (IN)

(21) Appl. No.: 15/123,659

(22) PCT Filed: Jun. 3, 2016
(86) PCT No.: PCT/IN2016/050165

§ 371 Date: Mar. 15, 2018

(30) Foreign Application Priority Data
Apr. 21, 2016 (IN) 201621013867

(51) Int. Cl. G03B 17/56; G03B 37/02; F16M 11/08; F16M 11/20; F16M 13/02; F16M 11/18

(52) U.S. Cl. CPC G03B 17/561; G03B 37/02; F16M 11/08; G06Q 30/0601; F16M 13/022; F16M 11/18; F16M 11/2021

(57) ABSTRACT

The present invention relates to the portable system to display the three dimensional view or 360 degree view of any Precious items, which mainly includes diamonds and jewelleries for online or display trading.

### FIELD OF THE INVENTION

The present invention relates to the portable system to display the three dimensional view or 360 degree view of any Precious items, which mainly includes diamonds and jewelleries for online or display trading. The present invention mainly provides/creates thee dimensional view display image of diamond and jewelleries and creates the systems and methods, which is more useful in online trading of stones. Specifically, embodiments of the present invention relate to systems, methods and devices that help optimize online trading of diamonds and jewelleries or any precious items. In the present invention system, such created display file are stored on cloud server to display on any computing device

### BACKGROUND OF THE INVENTION

Currently, the majority peoples are shopping online to get good offers or more options from the different merchants and services through associated websites for different products. Normally, with an internet based shopping system, a customer accesses a website, views products and/or services and associated specifications, chooses a product and/or service for purchase. Day by day there are new platforms are available to sell your products worldwide with secure e-commerce system.

However for buying any precious items, like diamond or any jewelleries, peoples are preferring physical shopping instead of online shopping for such goods because to buy such precious items, required to examine the items in three dimensional manner. Though the diamond & jewelleries are very costly items so, it required hung amount of investments and safety precaution to sell/buy it in limited market range. Sometime to avoid such risk, the merchant does not display the wide range of their products to their potential buyers. Sometime merchant has to display their products personally to the potential buyers, which also involve cost of insurance and safety precaution. To overcome such limitation, one system has required displaying such precious items with their three dimensional view and titling view to examine the items before selecting to buy. Presently there is no single system is available to display diamonds or jewelleries in three dimensional quality photographic presentation views or views of the jewelleries on titling angle.

In the published international patent WO2015132785 The subject matter disclosed herein is directed to a portable photographing apparatus configured to allow a user quickly and economically creating a high quality photographs of a small size item by a smartphone camera for professional inspection and analysis of the photographed item on an internet platform, said photographing apparatus comprising at least a photographing chamber configured to allow insertion and extraction of said small size item, said chamber comprising a rotatable stage for positioning said item within the photographing chamber and rotating the item during photographing so as to obtain a full view of the photographed item, and at least one light source for lighting said photographing chamber; said photographing chamber is connected to a power source and to a smartphone holder having a dedicated hole connected to a lens for allowing positioning of a Smartphone on said holder in a manner that said smartphone camera is positioned on said hole to obtain a sight view into said photographing chamber for photographing said item. The invention is further directed to a photographing system for small size items configured to allow a creation of an internet platform for professional inspection and analysis of photographed items by multiple users, said system comprising at least: (a) a portable photographing apparatus according to the above; (b) a smartphone having an intrinsic camera and a dedicated software application configured to obtain image data from said smartphone camera and upload the data to a server; and (c) a server having at least a web application with advanced image processing techniques for analyzing the uploaded images and creating a database of photographed items.

Another patent DE102013111488 where One method uses a collection of photographic images of an object taken from different angles, along with a set of geographical key parameters for each image section of the photo images to bring them to the 3D modeling data of the object in connection, which can be used to represent an a photo-realistic 3D high quality image in real time to a computing device. It also provides 3D geometry data for physical applications using an automatic or manual Photo receiving system, and the imported 3D modeling data of the same object with the same hardware system or by an independent 3D geometry scanning system, this information in a complete unit of files compiles means of manual, semi-automatic or automatic software tool to then be presented with a viewer with 3D environment. It can also extend to the stereoscopic system and provides real-time physical operation capabilities that result in high quality and realistic visual effects.

The above systems provide about the three dimensional view of diamond photographic views but to make the precise diamond and Jewelleries items, it required to provide more accurate platform with all possible option for viewing the products with high quality parameters. In the present invented system, provides three dimensional view of diamond with high quality parameters and also provides the facility to provide three dimensional view of jewelleries with their 360 degree rotational and view them at titling angle particularly for jewelleries items.

The present invention fulfill the need to produce high image quality, photo-realistic virtual reality presentation for commercial presentation of precise items with all possible views for the examination, and there is a need to include the geometry information for physical augmented reality view, especially for the desktop personal computers or mobile devices like tablet PCs and smart phones. To provide both the high quality viewing experience and the physical information, combining the merits of two different approaches of virtual reality of 3D view is a way to offer economic solutions and meet the quality requirement with the available computing devices. This invention achieves these goals and can be implemented with existing computing devices and mechanical systems.

### OBJECT OF THE INVENTION

The invention provides high quality photo presentation of diamonds and jewelleries with all viewing options.

The device has worked on predefine profile parameters so, has not required any skill person to operate which also reduce the presentation cost.

The device has provided with automatic or manually light controlling system to take the high quality photographic view.

The device has provided with separate photographic chamber, having different reflector system, which can be change according to the colour of diamond.

The present invented device has top and/or bottom rotating platform for rotating the object in three dimensional manner to take the photo on real-time basis.

The present invented device has provided with titling angle facility to view the small jewelleries items may be for example but not limited to, i.e. rings, bracelet, earrings, pendant for more precise examination.

In the present invention device camera holding system has provided with two dimensional angle adjustments.

In the present invention, real time image are loaded gradually to maintain the continuous rotations of display image.

The present invention is provided with multiple embodiments to use such system, which mainly includes rotational platform for diamond holding, tilting angle platform for small and medium size jewelleries and hanging option for jewelleries.

The other object of the present invention is provided to facility to select the diamond and put on diamond jewelleries to see their assembly view, which can help the buys for selection of Jewelleries or diamond very easy.

The further embodiment of the present invention is able to produce diamond's kaleidoscopic pattern images as well as 360 degree video for recognizing the proportion of diamond cuts, which is also known as heart & arrow or any predefine pattern of diamond in single operating machine. This heart & arrows add on is a reflecting optical symmetry tool, which can be easily fitted in present invention without changing camera and diamond's position. Camera is looking through the add on image will appear of arrow pattern radiating outward in the crown of area H&A diamond (Hearts & Arrows). Turn the diamond over and circle of hearts appears in the pavilion. The arrows pattern may also be seen in certain lighting or under magnification when mounted but the H&A add on is the tool that reveals hearts patterning in videography system. Diamond should stand vertically correct or all facets must be precisely aligned to appear correctly. If any part of the diamond is even slightly asymeetric or bend then the patterns will be unever or distorted.

The further object of the present invention system is using technology of photography by avoiding mechanical shutter of camera. In the present invention system, user can collect and store the live view for capturing images by zooming different area of subject by combining images to produce final image. System captures series of images to product 360 degree view of object. Different camera and light settings are there for customization. User can save profile for settings. System generate many output formats like video, HTML5 single file, Single Image file and Viewer supported set of file. User can search for previously scanned images. User can export images that was previously scanned.

### BRIEF DESCRIPTION OF THE DRAWINGS

It will be convenient to further describe the present invention with respect to the accompanying drawings that illustrate possible arrangements of the invention. Other arrangements of the invention are possible, and consequently the particularity of the accompanying drawings is not intended to be limiting of the present invention.

FIG. 1 represents the front view of the present invention system with vertical diamond stage.

FIG. 2 represents the front view of the present invention system with vertical diamond/jewelleries stage

FIG. 3 represents the sample view of round diamond arrow & heart Image sample

FIG. 4 represents the H&A add on placement arrangement in the present invented system.

### DETAILED DESCRIPTION OF THE INVENTION

Before explaining the present invention in detail, it is to be understood that the invention is not limited in its application to the details of the construction and arrangement of parts illustrated in the accompanying drawings. The invention is capable of other embodiments, as depicted in different figures as described above and of being practiced or carried out in a variety of ways. It is to be understood that the phraseology and terminology employed herein is for the purpose of description and not of limitation.

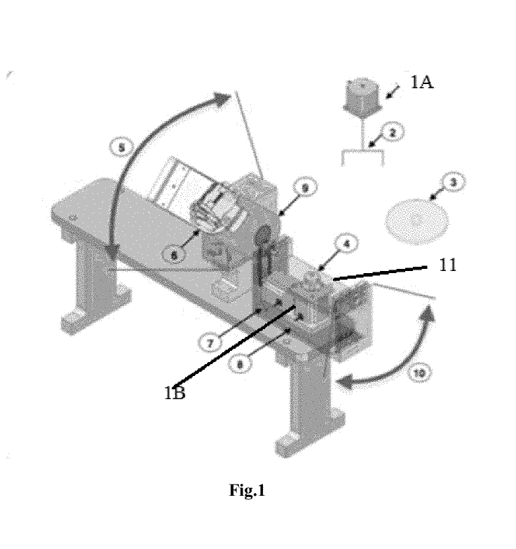

As shown in FIG. 1, the present invention is consists with three mothers, wherein one mother is fitted on top side of the device in reverse direction from top to bottom. This motor (1A) is connected with tilting/hanging item holder (2) to hang the jewellery items to take the photograph of rotating jewellery at 360° degree. This rotation is controlled by control card connected with the motor drive.

The second motor (1B) is fitted on the vacuum holding pipe (8) facing on top side to rotate the vertical diamond stage at 360° degree direction continuously which is also controlled by control card of the device.

The third motor (7) is fitted in horizontal direction to providing tilting angle of the device, which rotates the tilting plate in 30° to 60° degree rotation in clockwise and anticlockwise (both the) direction, which is also controlled by control card of the device.

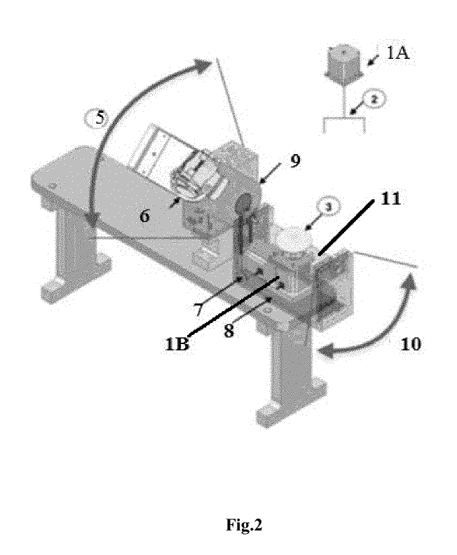

In the present invention diamond is hold by on vertical diamond stage (4) wherein the diamond is hold by the vacuum holding pipe (8), fitted in the centre of vertical diamond stage (4). The jewellery, diamond plate (3) is replace with vertical diamond stage (4) to fit on the device to provide alternate arrange of the device for the small and medium size jewelleries as shown in FIG. 2, wherein the small and medium size jewelleries are required to put on such jewellery, diamond plate (3) and which is rotates the tilting plates (11) in both direction (10) from 30° to 60° degree rotation in clockwise and anticlockwise (both the) direction, which is also controlled by control card of the device.

In the present invention as shown in FIG. 1, the camera (6) is fitted in adjustable/flexible arm (9) fitted with the photographic chamber, the camera can be adjusted according the requirement to focus on object to take the pictures.

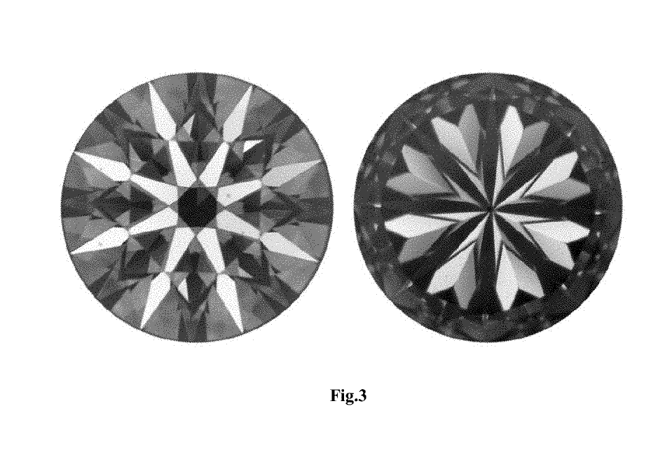

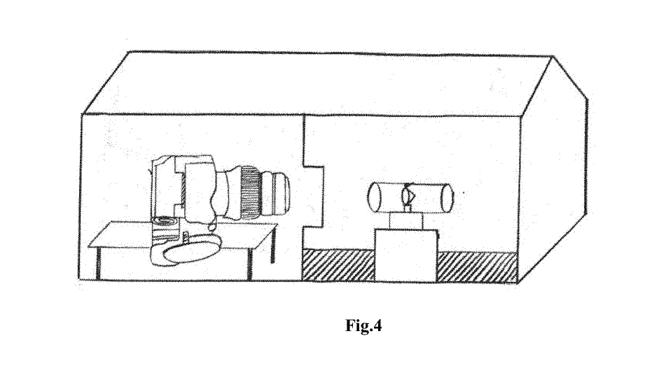

The present invention is able to produce diamond's kaleidoscopic pattern images as well as 360° degree video for recognizing the proportion of diamond cuts, which is also known as heart & arrow or any predefine pattern of diamond in single operating machine as explained in FIG. 3. This heart & arrows add on is a reflecting optical symmetry tool, which can be easily fitted in present invention without changing camera and diamond's position which is shown in FIG. 4. Camera is looking through the add on image will appear of arrow pattern radiating outward in the crown of area H&A diamond (HEART & ARROW DIAMOND). Turn the diamond over and circle of hearts appears in the pavilion. The arrows pattern may also be seen in certain lighting or under magnification when mounted but the H&A (HEART & ARROW DIAMOND). add on is the tool that reveals hearts patterning in videography system. Diamond should stand vertically correct or all facets must be precisely aligned to appear correctly. If any part of the diamond is even slightly asymeetric or bend then the patterns will be unever or distorted.

In the present invention, photographic chamber has provided reflectors on each surface, which can be changed according to the requirements While, the invention has been described with respect to the given embodiment, it will be appreciated that many variations, modifications and other applications of the invention may be made.

In the present invention, computer system is connected with camera to create the real image on computer screen to sends/upload through the Internet network to remote network storage server, which will load the images gradually while opening the real image of the diamond or jewellery to view.

In the present invention system is using technology of photography by avoiding mechanical shutter of camera. In the present invention system, user can collect and store the live view for capturing images by zooming different area of subject by combining images to produce final image. System captures series of images to product 360 degree view of object. Different camera and light settings are there for customization. User can save profile for settings. System generate many output formats like video, HTML5 single file, Single Image file and Viewer supported set of file. User can search for previously scanned images. User can export images that was previously scanned.

The internet connected server is compatible to view the real image on user interface computer device or mobile or tablet. The two dimensional photo picture images are capture frame by frame of each view position and then they are process to optically remove the background or compared into JPG format with high resolution. In the present invention, diamond or jewellery items are photographic with respect to rotational axis of moving object by camera by different angles to take the photos of rotating or fix object.

Described above, only the preferred embodiment of the present invention only, not for the present invention any formal restrictions, although the invention has been revealed as the preferred embodiment, however, not intended to limit the present invention, any skilled in the art technical staff, without departing from the scope of the present invention within the program, can be used when the contents of the above disclosed techniques make little changes or substitutions and changes in the equivalent embodiments, but any aspect of the invention without departing from the content, according to the present invention, technical substance of any of the above embodiments when taken in a simple modification, equivalent variation and modification as would fall within the scope of the present invention the technical solution.

I claim:

1. Portable system to create the display platform of three dimensional photographic view for Precious items comprising with three motor, control card, photographic chamber, camera holding/fixing arm (9), tilting/hanging item holder (2), vacuum holding pipe (8), tilting plate, vertical diamond stage (4), plate (3) and computer system
wherein first motor (1A) is fitted on top side of the device in reverse direction from top to bottom connected with tilting/hanging item holder (2), the second motor (1B) is fitted on the vacuum holding pipe (8) facing on top side to continuously rotate the vertical diamond stage at 360 degree direction, the third motor (7) is fitted in horizontal direction to providing tilting angle of the device,
wherein control card control the motor drive;
wherein photographic chamber is consists with reflector surface, lighting system, diamond holding stage or plate, tilting plate;
wherein camera holding/fixing arm is connected with photographic chamber;
wherein diamond holding stage is centrally connected with vacuum generating pipe from the centre of diamond holding stage;
wherein diamond or jewellery holding plate is alter with diamond holding stage

2. Portable system to create the display platform of three dimensional photographic view for Precious items as claimed in claim 1 wherein the tilting plate rotates at 30° to 60° degree in clockwise and anticlockwise (both the) direction.

3. Portable system to create the display platform of three dimensional photographic view for Precious items as claimed in claim 1 wherein the tilting/hanging holder is connected with first motor to rotate the hanging object at 360° in the photographic chamber.

4. Portable system to create the display platform of three dimensional photographic view for precious items as claimed in claim 1 wherein camera is fitted on camera holding arm (9), which can be adjust in horizontal, vertical or incline 360° to adjust the camera focal length.

5. Portable system to create the display platform of three dimensional photographic views for precious items as claimed in claim 1 wherein control card connected with motor driver to control the rotational speed of the motor and light intensity.

6. Portable system to create the display platform of three dimensional photographic view for precious items as claimed in claim 1 wherein the photographic images are gradually upload from the server to displace the real time image on computer screen.

7. Portable system to create the display platform of three dimensional photographic view for precious items as claimed in claim 1 wherein the display system has provided facility to see the assembly view of the selected diamond on selected jewellery.

8. Portable system to create the display platform of three dimensional photographic view for precious items as claimed in claim 1 wherein user can create, store, search & export the different profile of captures series of images for previously scanned images.

9. Portable system to create the display platform of three dimensional photographic view for precious items as claimed in claim 1 wherein system is produce diamond's kaleidoscopic pattern images as well as 360 degree video for recognizing the proportion of diamond cuts, which is also known as heart & arrow or any predefine pattern of diamond in single operating machine.

10. Portable system to create the display platform of three dimensional photographic view for precious items as claimed in claim 1 wherein the optical symmetry tool is provided on diamond holding stand for reflecting hearts & arrows pattern in video-graphy system.
